(19) United States
(12) Patent Application Publication
(10) Pub. No.: US 2015/0026114 A1
(43) Pub. Date: Jan. 22, 2015

(54) SYSTEM AND METHOD OF AUTOMATICALLY EXTRACTING DATA FROM PLURALITY OF DATA SOURCES AND LOADING THE SAME TO PLURALITY OF TARGET DATABASES

(71) Applicant: Dania M. Triff, Miami, FL (US)

(72) Inventor: Dania M. Triff, Miami, FL (US)

(21) Appl. No.: 13/944,934

(22) Filed: Jul. 18, 2013

(51) Int. Cl. G06F 17/30

(52) U.S. Cl. CPC G06F 17/30563
USPC 707/602

(57) ABSTRACT

The present invention discloses system and method for automatically extracting data from plurality of data sources in various formats through source channels and loading data to plurality of target databases through connectors. The system includes a data transformation module for transforming data received from the plurality of data sources, a data processing module for automatically analyzing and organising the received data for loading into the plurality of target databases, and a metadata repository for storing metadata of the processed data for future usage. The metadata regarding data structure of the data sources is automatically extracted from the data sources and used to create predefined data structures of the target databases. The data processing module includes a data input handling module for identifying mime-type, extension and the metadata of the data sources, a data structure identification module for identifying type and subtype of the data sources and a target-data-structure creation module for creating the predefined data structures of the target databases.

### CROSS-REFERENCE TO RELATED APPLICATION

This application claims benefit of priority of US Provisional Patent Application Ser. No. 61/706, 539, filed Sep. 27, 2012, entitled “SYSTEM AND METHOD FOR AUTOMATICALLY EXTRACTING DATA AND LOADING SOURCE FILES TO A FILE SYSTEM OR DATABASE TARGET”, owned by the assignee of the present application and herein incorporated by reference 5 in its entirety.

### FIELD OF THE INVENTION

The present invention generally relates to the field of data storage and processing. In particular, the present disclosure relates to systems and methods for automatically extracting data from plurality of data sources and loading data to plurality of target databases.

### BACKGROUND OF THE INVENTION

A businesses corporation receives data in a variety of forms and from disparate sources. The data can be either structured or unstructured and can be received from internal operational systems, other departments, external business partners, or other marketing sources. Storing and analyzing such data received from the variety of sources is a vital requirement for business corporations.

There exists a variety of tools in the market specifically designed to extract, transform, and load (“ETL”) data into corporate databases or data warehouses. These existing tools require extensive human interactions and efforts from software engineers to database developers in order to analyze the details of each file, extract the structure of the data, model the databases, and write the mappings that allow the interpretation and loading of the incoming files into the corporate databases.

With the existing ETL tools, a company needs to budget for a project with software engineers to analyze the structure of the incoming file and manually prepare the enterprise system to organise and store this data. For example, when a company starts to receive data, such as, invoice data from files in delimited text format, the company needs to budget projects to model and create database schemas and mappings for the corresponding fields.

The concept of ETL requires extracting data from the source, transforming data applying business-defined rules, implementing cleaning processes, and loading the data into target databases.

However, the challenge is that the requirement of data business is changing rapidly. An increasing amount of data is now received from unstructured sources such as speech data, audio digital files, videos, web click information and so forth. Data storage and analysis concepts are also changing. At the same time, storage is becoming cheaper, compression mechanisms are becoming more efficient, and new ways of storing and analyzing information in massive parallel ways is helping to reduce the lengthy transformation and cleaning projects to processes the business cases before loading data in the enterprises.

Therefore, there exists a need to provide an improved system and method for automatically extracting data from various data sources and loading the data to plurality of target databases which may overcome the problems with the existing systems, designs, and processes as discussed above.

### SUMMARY OF THE INVENTION

The main object of the present invention is to provide an improved system and method for automatically extracting data from plurality of data sources and loading the same to a plurality of target databases, which eliminates human intervention.

Another object of the present invention is to provide an improved system and method for automatically extracting data from plurality of data sources and loading the same to a plurality of target databases, which may read structured and unstructured data from any source, in any format, and load into a database.

Another object of the present invention is to provide an improved system and method for automatically extracting data from plurality of data sources and loading the same to a plurality of target databases faster, which eliminates need of creating or maintaining code, scripts, mappings or tables.

Another object of the present invention is to provide an improved system and method for automatically extracting data from plurality of data sources and loading the same to a plurality of target databases, which may create the data structures for any type of target database.

Another object of the present invention is to provide an improved system and method for automatically extracting data from plurality of data sources and loading the same to a plurality of target databases, which may provide an interface for optional human intervention to further refine the data structures.

Another object of the present invention is to provide an improved system and method for automatically extracting data from plurality of data sources and loading the same to a plurality of target databases, which may accumulates information and learns from all files and user inputs.

Another object of the present invention is to provide an improved system and method for automatically extracting data from plurality of data sources and loading the same to a plurality of target databases, which may keep metadata of the characteristics of the files and each step of the loading process for every file processed.

In order to achieve the above mentioned objects, the present invention discloses a system for automatically extracting data from one or more data sources in various formats through one or more source channels and loading data contained therein to one or more target databases through one or more connectors. The system includes a data transformation module for transforming data received from the one or more data sources, a data processing module for automatically analyzing and organising the received data for loading into the one or more target databases and a metadata repository for storing metadata of the processed data for future usage, wherein the metadata regarding data structure of the one or more data sources is automatically extracted from the data sources and used to create predefined data structures of the one or more target databases.

In one embodiment, the data processing module further includes a data input handling module for identifying mime-type, extension and the metadata of the one or more data sources, a data structure identification module for identifying type and subtype of the one or more data sources and a target-data-structure creation module for creating the predefined data structures of the one or more target database.

In one embodiment, the system for automatically extracting data from one or more data sources further includes a user interface for showing the results of the analysis and the inferred data structures by the data processing module to a user.

In one embodiment, the metadata repository includes a set of tables to store at least one of system metadata, file types, sub-types, data processing details, source channel and target database connection characteristics.

In one embodiment, the source channels may include databases, email messages, FTP servers, file directories, web services and webpages.

In one embodiment, the one or more data sources may include text/html, text/plain, text/xml, excel, jpeg, zip, jar, cab, gzip and rar.

In one embodiment, the one or more target databases may include SQL or NOSQL target databases.

In another aspect of the invention, a method is disclosed for automatically extracting data from one or more data sources through one or more source channels and loading data contained therein to one or more target databases. The method includes loading one or more data sources from one or more source channels, transforming data received from the one or more data sources by a data transformation module, analyzing and organising the received data automatically for loading into the one or more target databases by a data processing module, generating predefined data structures of the one or more target databases and loading therein through one or more connectors and storing metadata of the processed data for future usage by a metadata repository, wherein the metadata regarding data structure of the one or more data sources is automatically extracted from the data sources and used to create predefined data structures of the one or more target databases.

In one embodiment, the analyzing and organising the received data automatically by the data processing module may include machine learning, heuristics and statistical analysis.

In one embodiment, the analyzing and organising the received data automatically by the data processing module may include identifying mime-type, extension and the metadata of the one or more data sources or identifying type and subtype of the one or more data sources or the combination of both the steps.

In one embodiment, the method of automatically extracting data from one or more data sources includes displaying the results of the analysis and the inferred data structures to a user on a user interface.

In one embodiment, the method of automatically extracting data from one or more data sources includes receiving user inputs for correcting information and entering additional file and data structures that override the automatically inferred data structures.

In one embodiment, the method of automatically extracting data from one or more data sources includes automatically re-creating the data structures of the one or more target databases and reprocessing the data based on the new data structures.

In one embodiment, the method of automatically extracting data from one or more data sources includes maintaining a history of the file types and subtypes and the metadata. In another embodiment, the method includes combining the results of current file structure identification with a statistical analysis of the history of the previous file structures. In yet another embodiment, the method includes improving the automatic identification of future data sources based on the previously processed file structures of the one or more data sources.

In another aspect, the present invention discloses a computer program product, comprising a computer usable medium having a computer readable program code embodied therein, said computer readable program code adapted to be executed to implement a method of automatically extracting data from one or more data sources through one or more source channels and loading data contained therein to one or more target databases. The method includes loading one or more data sources from one or more source channels, transforming data received from the one or more data sources by a data transformation module, analyzing and organising the received data automatically for loading into the one or more target databases by a data processing module, generating predefined data structures of the one or more target databases and loading therein through one or more connectors and storing metadata of the processed data for future usage by a metadata repository, wherein the metadata regarding data structure of the one or more data sources is automatically extracted from the data sources and used to create predefined data structures of the one or more target databases.

It is to be understood that both the foregoing general description and the following detailed description of the present embodiments of the invention are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and together with the description serve to explain the principles and operation of the invention.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block diagram illustrating a system for automatically extracting data from plurality of data sources and loading the same to a plurality of target databases according to one embodiment of the present invention;

FIG. 1a is a block diagram illustrating internal functional blocks of the data structure identification module according to one embodiment of the present invention;

FIG. 2 is a diagram of an exemplary embodiment of a configuration of a source channel;

FIG. 3 is a diagram of another exemplary embodiment and configuration of a source channel;

FIG. 4 is a diagram of a further exemplary embodiment and configuration of a source channel;

FIG. 5 is a diagram of an exemplary embodiment and configuration of an input channel having a selectable process type for each file type;

FIG. 6 is a diagram of an exemplary embodiment and configuration of an input channel having a selectable process by sub-type;

FIG. 7 is a diagram of an exemplary embodiment and configuration of connection settings for a target connection;

FIG. 8 is an exemplary embodiment of a data structure of a target database processed by the data processing module;

FIG. 9 is another exemplary embodiment of a data structure of a target database processed by the data processing module;

FIG. 10 is an exemplary embodiment of a table structure for a dXML table;

FIG. 11 is an exemplary embodiment of a Data Definition Logic (DDL) generated for all tables for the processed target data; and

FIG. 12 is an exemplary embodiment of a table of the processed data.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a nonexclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Reference will be made in detail to the exemplary embodiment(s) of the invention, examples of which are illustrated in the accompanying drawings. Whenever possible, the same reference numerals will be used throughout the drawings to refer to the same or like parts.

Disclosed herein is a system and method for extracting data from data sources of any type and loading the data to a variety of target databases. The system automatically extracts information, such as metadata, extension, file type and subtype and so forth from files of any type and loads the extracted information in configurable target databases or target systems. The system automatically creates the necessary data structures without the need for human intervention.

The system organizes, monitors, and loads files of any type into different target databases. The system extracts as much information as possible from each data sources and files and the content of each file. In addition, the system keeps a searchable history of the loading process.

The system allows for the configuration of source channels for source data. The source data can be read from a variety of source channels. For example, a source channel can be an email box, a file transfer protocol (FTP) server, a file directory and so forth. The present system controls the flow, processes the data and keeps information regarding file properties, the time of the load, and the results and characteristics of the load process.

The system can automatically identify the source file type. In one exemplary embodiment, the source file type can be determined using an open source, file footprint identification algorithm. For example, Tika is the open source file footprint identification algorithm. The system can also classify the file based on a sub-type. The file subtype is extracted by further analyzing the binary data and inferring a data structure (if applicable).

The system configures the target databases by creating connections through connectors. The target databases may be any commercial database or file system. The system automatically routes data sources and files to different target databases. The routing of the data sources and files may be configured based on characteristics of the input files, including but not limited to specific source channel, source channel type, file type, file sub-type and so forth. In one exemplary embodiment, the system can automatically create the data schema and structures on the target databases when the defined target is a structured database.

The system analyzes the file and automatically extracts data structure and organization information. In one exemplary embodiment, an optional user interface is provided that shows the results of the analysis and the inferred data structures processed by the data processing module to a user. In this embodiment, the system allows the user to correct information and enter additional file and data structures that override or enrich the automatically inferred metadata. In one exemplary embodiment, the system automatically re-creates the target data structures and reprocesses the files based on enriched or new data structures if programmed by the user to do so.

The system keeps a history of all the processed data sources, file types and subtypes and learns from the loading experience and any other optional information corrected or added by a user. The system learns by combining the results of the file structure identification algorithm with a statistical analysis of the history of the files with similar properties that have been previously identified.

In one exemplary embodiment, the system cleans and transforms the data sources and files before sending them through the identification and loading process. The system may optionally call an external commercial data transformation product or tool in order to perform the cleaning and loading operation.

### Method:

The method for automatically extracting data from a plurality of data sources and loading the data to a plurality of target databases is now disclosed with further details. According to one exemplary embodiment, a source channel is configured for each data source. The source channels may be any known measures for electronically receiving the data sources and files.

One or more files may be received from each data source. The one or more files may include structured and/or unstructured data. Each of the one or more files is associated with its respective source channel.

Information is extracted from each of the one or more data sources and files. The organization and structure of data inside the one or more data sources and files is automatically identified. The structure inside the file is automatically recognized by using one or more of machine learning, heuristics and statistical analysis. In one exemplary embodiment, the type or footprint of the files is identified. In one exemplary embodiment, a file sub-type and/or structure of the data inside the file is identified.

In another embodiment, the file sub-type or data structure can be further modified or further enriched by the user. For example, before delivery of processed data to a target database, the file structure or sub-type may be displayed using a graphical user interface for the user to interact with and to allow additions and modifications to be made.

The target data structure information is automatically created from the extracted information. The one or more data sources and files are related to a processing type. The type of file processing can be selected and defined based on various criteria, such as source channel, file type or sub-type, and any of the file operating system associated properties and so forth. Examples of file operating system associated properties may include file name, file extension, size, data and so forth. The processing type may include a call to an external file pre-process system. The processing type also can be file identification or file identification and automatic loading. In one exemplary embodiment, the one or more files can be re-created and the target data structures can be re-created based on changes to the data structure.

The target data structure information from each data source and each file is loaded into a respective target database. The target database may be selected based on target connections. Target connections are created and the specific characteristics of each connection and data definition language (DDL) are taught to the system. This may be entered through a user interface or through lookup tables. The target database may be any structured row or columnar database, data warehouse appliance, or specific file system including distributed file systems, such as HDSF. In one exemplary embodiment, the one or more files can be re-processed and data may be stored in different targets by changing the target connections.

In one exemplary embodiment, a history of details about the extracted data structures of files and file processing results is maintained. Accordingly, tabular and graphical reports regarding any of the stored data can be generated.

### System:

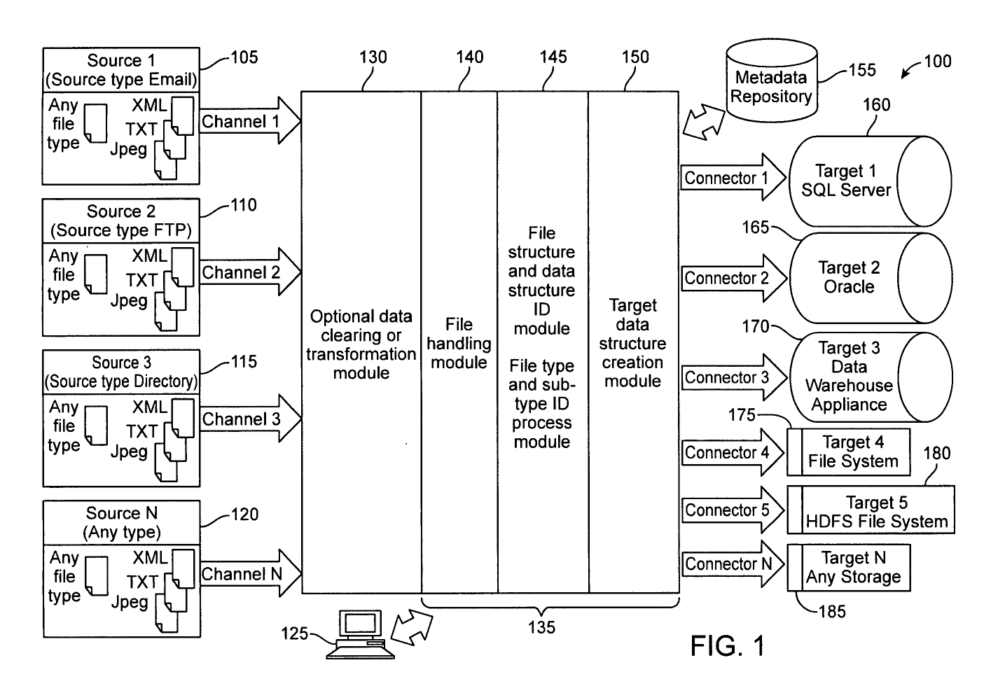

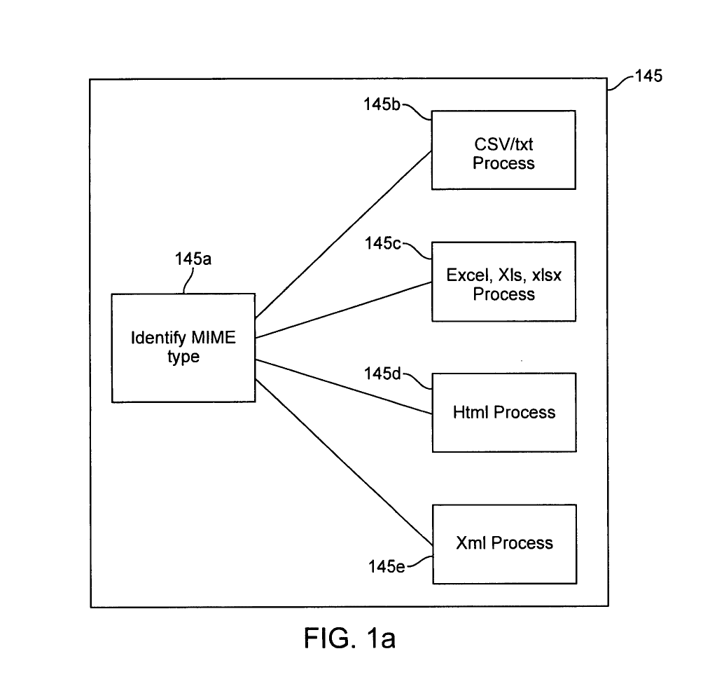

FIG. 1 illustrates a system 100 for automatically extracting data from plurality of data sources and loading the data to a plurality of target databases, according to one exemplary embodiment of the present invention. A plurality of data sources 105, 110, 115, 120 sends data to a data processing module 135 through a plurality of source channels such as channel 1, channel 2, channel 3, channel N and so forth. The plurality of data sources may be email 105, file transfer protocol (FTP) 110, a directory 115, or any source type 120. The file types may be Extensible Markup Language (XML), text (TXT), Joint Photographic Experts Group (JPEG), or any other file types. Optionally, data can be cleaned or transformed at a data transformation module 130 before being passed on to the data processing module 135.

The data processing module 135 may be implemented on a computer. In one exemplary embodiment, the computer is a server. The server may comprise a processor (CPU), a memory, such as, random access memory (RAM) and/or read only memory (ROM), and various input/output devices (for example, storage devices, including but not limited to, a tape drive, a floppy drive, a hard disk drive or a compact disk drive, a receiver, a transmitter) and other devices commonly required in data processing. The processes described in this disclosure may be implemented in general, multipurpose or single purpose processors. Such a processor may execute instructions, either at the assembly, compiled or machine-level, to perform that process. Those instructions may be written by one of ordinary skill in the art following the description of this disclosure and stored or transmitted on a computer readable medium, such as, a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (such as, removable, non-removable, volatile or non-volatile), and packetized or non-packetized wireline or wireless transmission signals. A set of tables is created in a metadata repository to store system metadata, such as, file types, sub-types, file processing details, and source channel and target connection characteristics.

The data processing module 135 includes a data input handling module 140, a data structure identification module 145, and a target-data-structure creation module 150. The data structure identification module 145 includes a MIME type identification module for identification of file structure and data structure and for identification of a file type and sub-type.

FIG. 1a illustrates internal functional blocks of the data structure identification module 145 according to one embodiment of the present invention. The data structure identification module 145 includes MIME type identification module 145a and data processing modules such as CSV/text process module 145b, Excel/Xls/Xlsx process module 145c, HTML process module 145d and XML process module 145e. Detail functions of each module are listed below:

### CSV/Text Process Module 145b:

1) The method GetIniTable( ) is called. The first ten lines are processed character by character to detect column delimiter, the line where the table starts, the number of columns, column names in the first row and (optional) metadata information. If a concise and repeatable format can be identified the algorithm detects the beginning of a table.

2) The file is scanned line by line from the detected beginning of the table until the end in the search for multiple tables. A different table is identified comparing the number of columns with the previous line.

3) Each row is divided with the identified delimiter and the data type of the column is identified using data type conversion functions and trapping the errors. Also the length of each column is determined counting the number of characters.

4) Each identified table structure is saved in the database.

5) The process is repeated as many times as required (number of tables).

6) If column delimiter is not found the file is assumed to be fixed length

7) The length and type of the column is identified parsing the file line by line and looking for consistent space characters.

### Excel/Xls/Xlsx Process Module 145c:

1) A new table is created for each Excel worksheet.

2) Starting for the left top corner, the place is detected in which each table starts.

3) Each row is divided in columns, for each column the information regarding type of data, length and name of the column.

### HTML Process Module 145d:

The application defines in each web page, tags or selector for the page.

1) For each selector, all the html elements are analyzed and for each the following data is extracted as table structure, type of data, length and name of each column.

2) Each new table is stored in the structure database.

3) If an element contains a link to another page (sublink) the same html data process is repeated for each new page unless the structure already exists in the database.

4) Each new table is stored in the structure database. When a new link is detected, it is always researched if the link happened.

### XML Process Module 145e:

1) Each XML node is identified

2) Each new XML node is assigned to a new table structure.

3) New columns are added to the file to store the parent child relationship.

4) The parent-child relationship is extracted from the file and new columns are added to the data structure.

The source channels may be configured for each data source. The configuration can be done, for example, by a user interfacing with the data processing module 135 using the computer 125.

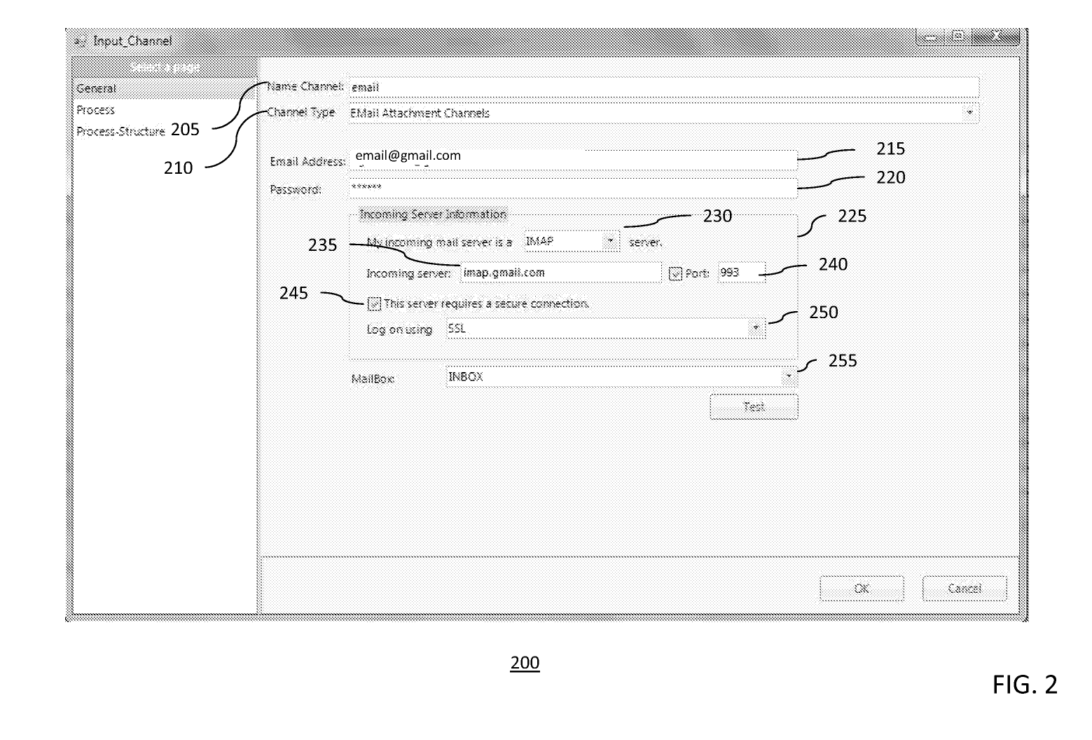

FIG. 2 illustrates an exemplary configuration 200 of a source channel. In this example, the source channel is an email channel. The email channel has various configuration fields including, but not limited to, a channel name field 205, a channel type field 210, an email address field 215, a password field 220, incoming server information fields 225, and a mailbox field 255. The incoming server information fields 225 allow the user to select an incoming server type 230, a server address 235, and a port 240 (if necessary). If a secure connection is necessary, this option may be selected at item 245. The type of secure connection is selectable at item 250.

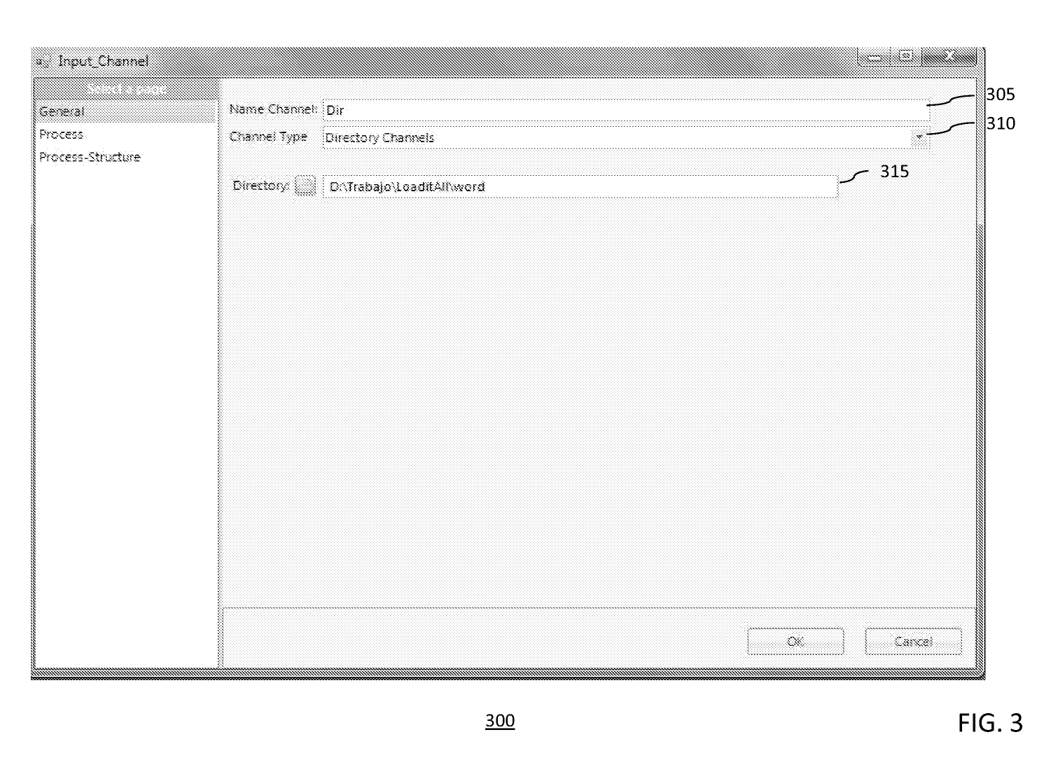

FIG. 3 illustrates an exemplary embodiment of a configuration 300 of another source channel. In this example, the source channel includes a directory channel. The directory channel has various configuration fields including, but not limited to, a channel name field 305, a channel type field 310, and a directory path field 315.

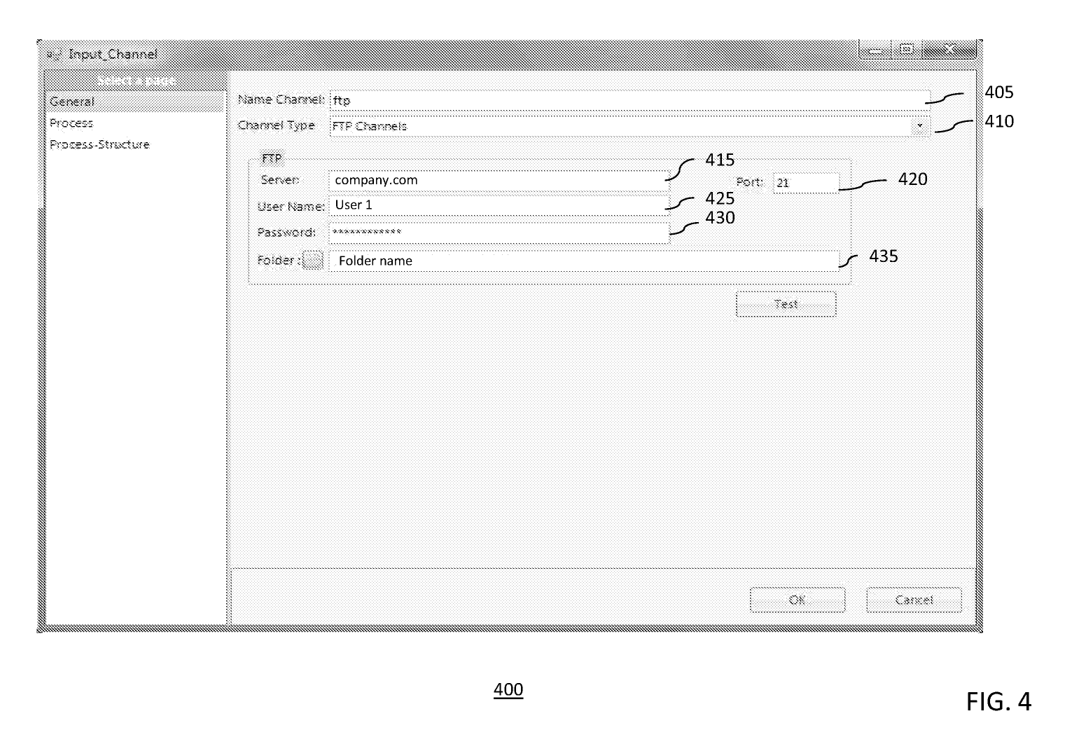

FIG. 4 illustrates an exemplary embodiment of a configuration 400 of a source channel, in which the source channel is a FTP channel. The FTP channel has various configuration fields including, but not limited to, a channel name field 405, a channel type field 410, a server address field 415, a user name field 425, a password field 430, a port field 420, and a folder name 435.

As explained above, one or more files is received from each data source. The one or more files may include structured and/or unstructured data. Further, each of the one or more files is associated with a respective source channel.

Information is extracted from each of the one or more files. The organization and structure of data inside the one or more files is identified automatically. The structure inside the file is recognized automatically by using one or more of machine learning, heuristics, and statistical analysis. In one exemplary embodiment, the type or footprint of the files is identified. In another exemplary embodiment, a file sub-type and/or structure of the data inside the file is identified.

The file sub-type or data structure can be further modified or further enriched by the user, before delivery of processed data to a target system. In one exemplary embodiment, the file structure or sub-type is displayed in a graphical user interface to allow the user to interact with the data and allows additions and modifications to be made. These embodiments can be implemented, for example, by allowing a user to interface with automatic file processing schema 135 using computer 125.

The target data structure information is automatically created from the extracted information. The one or more files are related to a processing type. The type of file processing can be selected and defined based on various criteria, such as, the file channel source, file type or sub-type, and any of the file operating system associated properties. Examples of file operating system associated properties include file name, file extension, size, data and so forth. In one exemplary embodiment, the processing type may include a call to an external file pre-process system. In another exemplary embodiment, the processing type can be file identification or file identification and automatic loading. In yet another exemplary embodiment, the one or more files can be re-created and the target data structures can be re-created based on changes to the data structure.

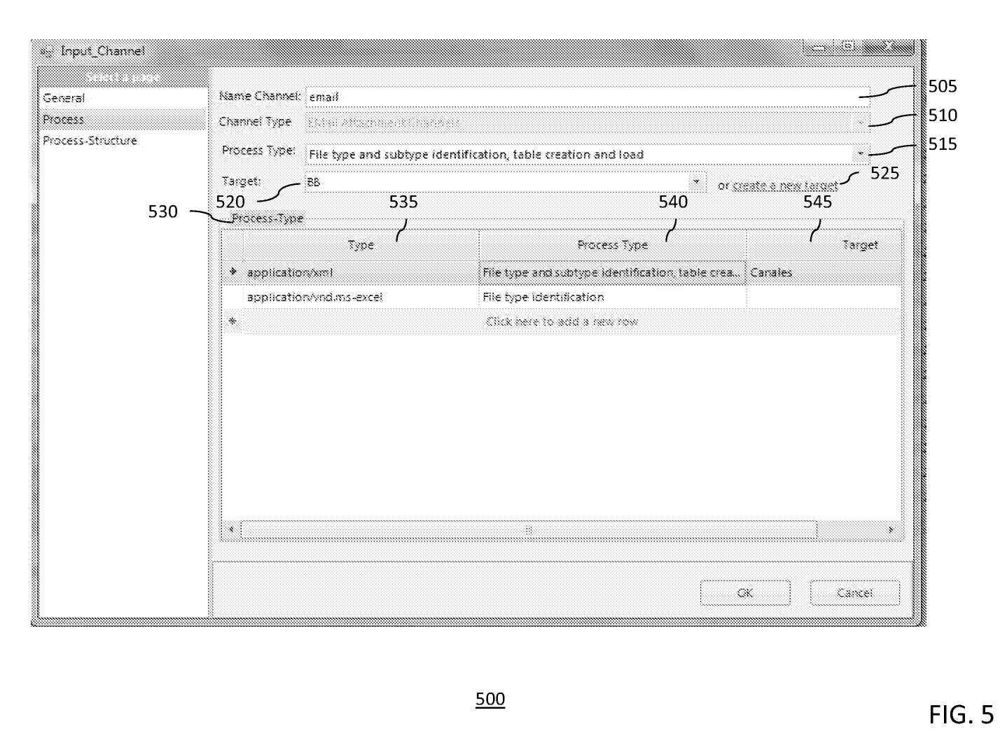

Data that comes from a certain source is processed a certain way. The process may change based on channel, type, and sub-type. FIG. 5 illustrates an exemplary embodiment of a configuration 500 of an input channel having a selectable process type for each file type. Configuration 500 has various fields for configuring the process type including, but not limited to, a channel name field 505, a channel type field 510, a process type field 515, and a target field 520. A new target can be created by selecting link 525. The process type can be configured by selecting a file type 535, a process type 540, and a target 545.

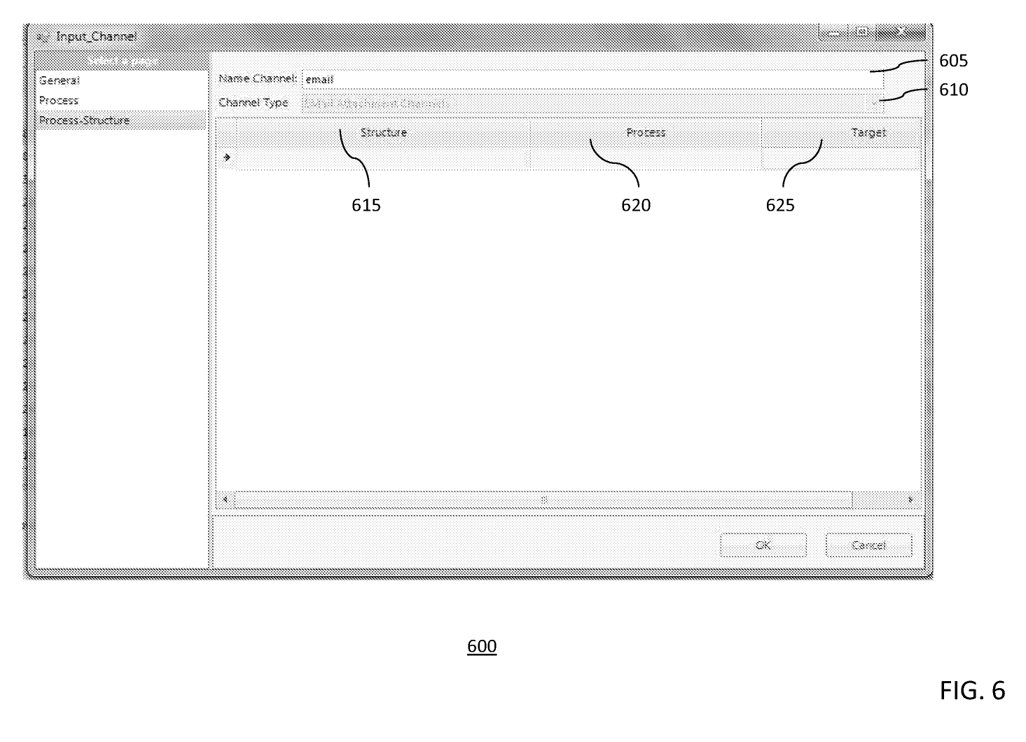

FIG. 6 illustrates an exemplary embodiment of a configuration 600 of an input channel having a selectable process by sub-type. Data from each file can be processed according to a structure of a file type. For example, the file type can be XML and the sub-type is defined by the data structure defined by the XML language. Configuration 600 has various fields for configuring the process by sub-type including, but not limited to, a channel name field 605, a channel type field 610, a structure field 615, a process type field 620, and a target field 625.

Referring back to FIG. 1, the target-data-structure creation module 150 sends data to a plurality of target databases 160, 165, 170, 175, 180, 185 through a plurality of connectors (connector 1, connector 2, connector 3, connector 4, connector 5, . . . , connector N). The target databases may be a Structured Query Language (SQL) server 160, an Oracle™ database 165, a data warehouse appliance 170, a file system 175, a Hadoop Distributed File System (HDFS) 180, or any type of storage system.

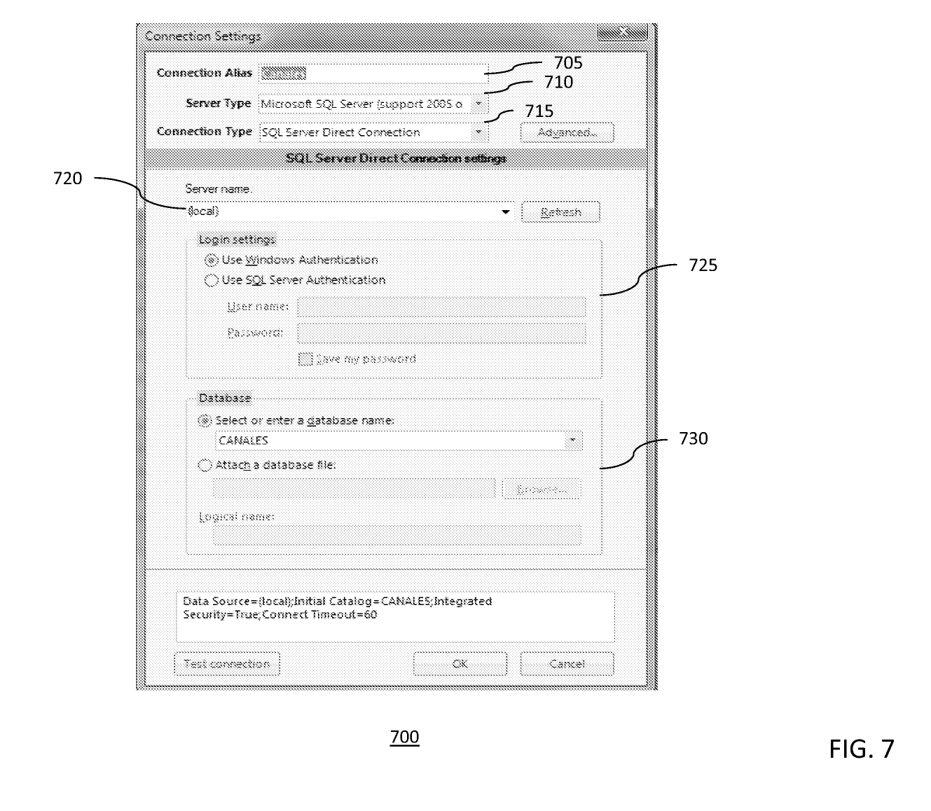

FIG. 7 illustrates an exemplary embodiment of a configuration 700 of connection settings for a target connection. Configuration 700 has various fields for configuring the target including, but not limited to, a connection alias field 705, a server type field 710, a connection type field 715, and a server name field 720. Configuration 700 also includes fields for login settings 725 and database settings 730 for database file attachment or database name selection or entry.

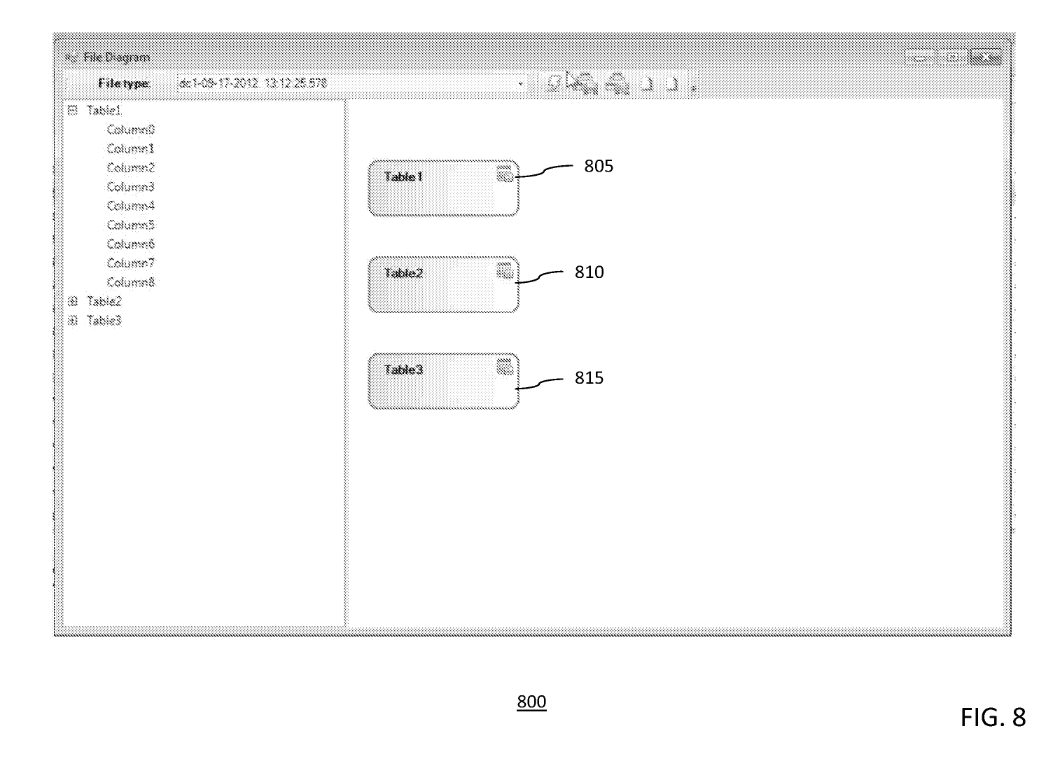

FIG. 8 illustrates a file diagram or structure of target data processed by the file processing module 135 according to one exemplary embodiment. In this configuration, data of a certain file type is processed and presented using the structure of tables 805, 810, 815.

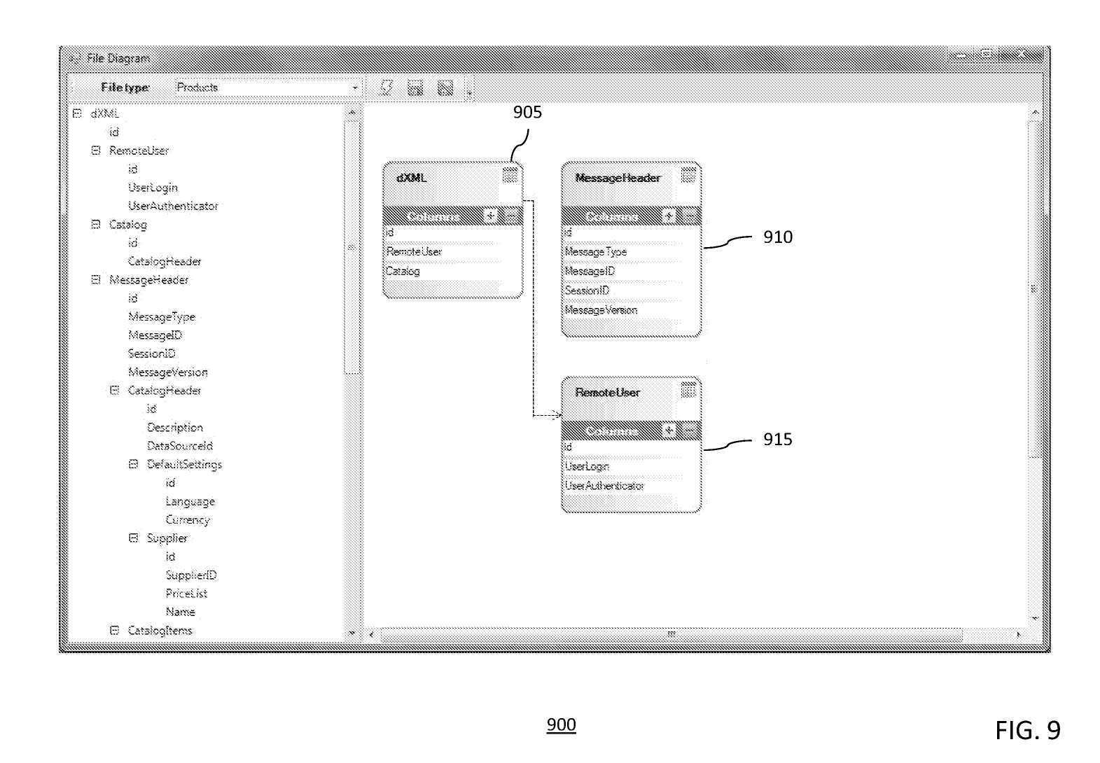

FIG. 9 illustrates an exemplary embodiment of a file diagram or structure of target data processed by the data processing module 135. In this configuration, XML data is processed and presented using the structure of tables 905, 910, 915. In the present embodiment, dXML table 905 includes ID, remote user, and catalog data. Message header table 910 includes ID, message type, message ID, session ID, and message version data. The remote user table 915 includes ID, user login, and user authenticator data.

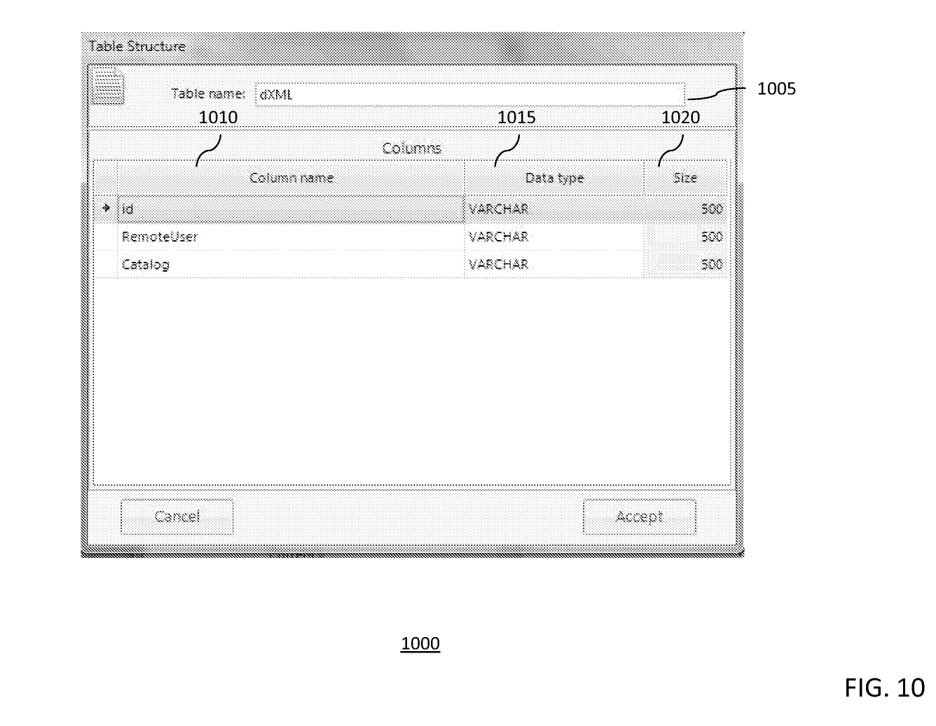

FIG. 10 illustrates an exemplary embodiment of a table structure for a dXML table 905. The table structure has a table name field 1005. The column name 1010 can be inferred and the data type 1015 and size 1020 for each column name can be automatically selected by the data processing module 135. The data type field 1015 and data size field 1020 can also be modified by a user.

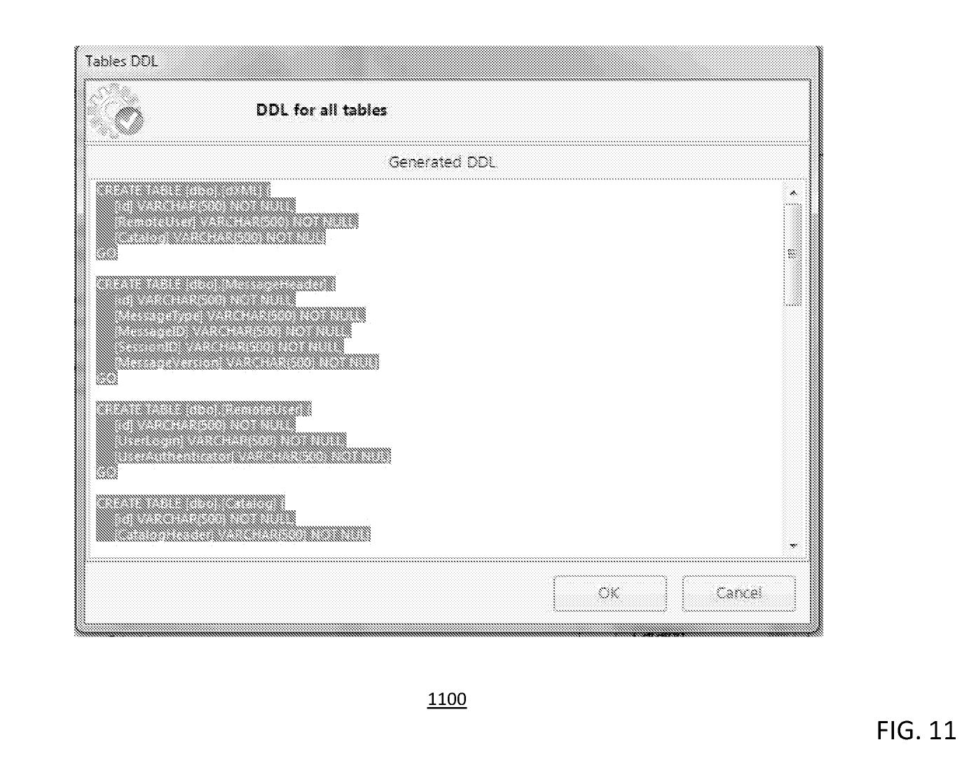

The target data structure information to store data from the file is inferred from the file content and can be automatically created into a target system, when the target system is a structured database. The target database can be selected based on target connections. The target connections are created. The specific characteristics of each connection and data definition language (DDL) can be taught to the system through a user interface or through lookup tables. The target system can be any structured row or columnar database, data warehouse appliance, or specific file system including distributed file systems, such as, HDSF. In one exemplary embodiment, the one or more files can be re-processed and data stored in different targets by changing the target connection. FIG. 11 illustrates an example DDL generated for all tables for the processed target data, according to one exemplary embodiment.

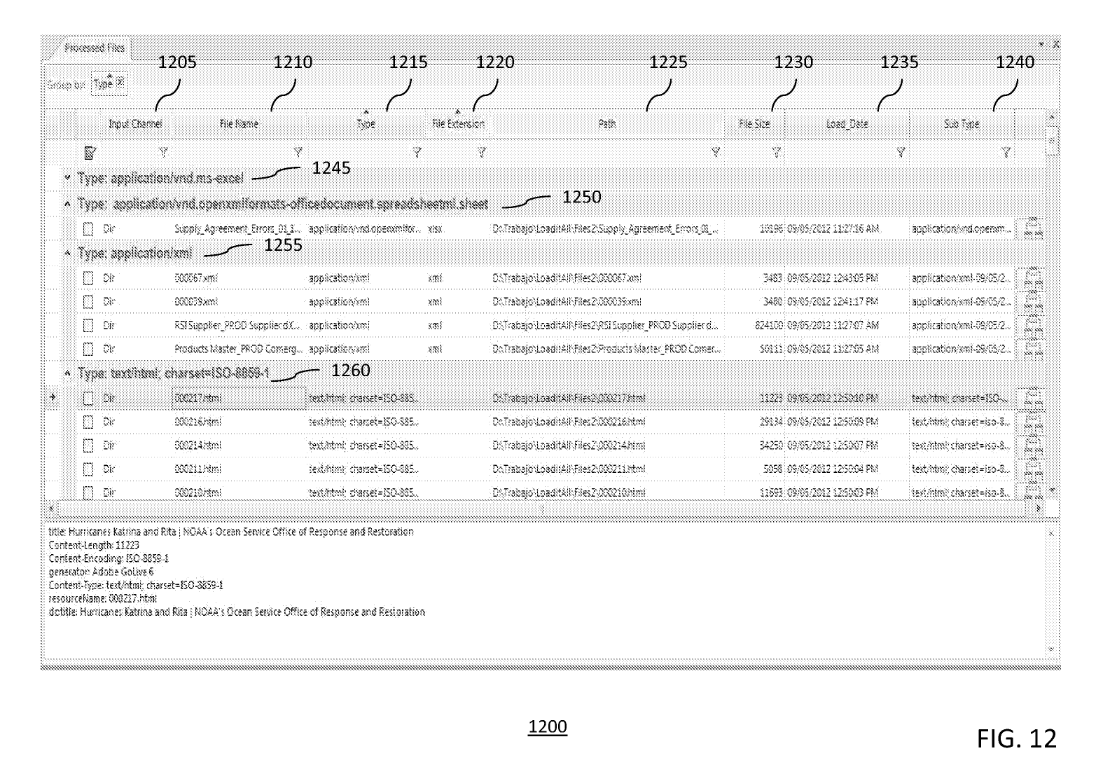

In one exemplary embodiment, a history of details about the extracted file structure and file processing results is kept. Tabular and graphical reports regarding any of the stored data can be generated. FIG. 12 illustrates an example table of processed files 1200 according to one embodiment. Table 1200 has various fields including, but not limited to, input channel 1205, file name 1210, file type 1215, file extension 1220, path 1225, file size 1230, load date 1235, and sub-type 1240. Table 1200 can also present data by data type 1245, 1250, 1255, 1260 (for example, MS excel, spreadsheet, XML, text and so forth) with respect to fields 1205, 1210, 1215, 1220, 1225, 1230, 1235, 1240.

The present system allows the automatic loading of files in a variety of target databases without the need for human intervention to identify the file structure in a way that is not possible with the existing ETL tools. The present system removes the need for modelling and manual creation of tables in database targets to load data from files. The present system tracks and keeps a history of the loading process. An interface that allows the user to report on the details and results of the file load process is provided by the present system.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

We claim:

1. A system for automatically extracting data from one or more data sources in various formats through one or more source channels and loading data contained therein to one or more target databases through one or more connectors, the system comprising:
a data transformation module for transforming data received from the one or more data sources;
a data processing module for automatically analyzing and organising the received data for loading into the one or more target databases; and
a metadata repository for storing metadata of the processed data for future usage,
wherein the metadata regarding data structure of the one or more data sources is automatically extracted from the data sources and used to create predefined data structures of the one or more target databases.

2. The system for automatically extracting data from one or more data sources as claimed in claim 1, wherein the data processing module further comprises:
a data input handling module for identifying mime-type, extension and the metadata of the one or more data sources;
a data structure identification module for identifying type and subtype of the one or more data sources; and
a target-data-structure creation module for creating the predefined data structures of the one or more target databases.

3. The system for automatically extracting data from one or more data sources as claimed in claim 1, further comprises a user interface for showing the results of the analysis and the inferred data structures by the data processing module to a user.

4. The system for automatically extracting data from one or more data sources as claimed in claim 1, wherein the metadata repository comprises a set of tables to store at least one of system metadata, file types, sub-types, data processing details, source channel and target database connection characteristics.

5. The system for automatically extracting data from one or more data sources as claimed in claim 1, wherein the one or more source channels comprises at least one of databases, email messages, FTP servers, file directories, web services and webpages.

6. The system for automatically extracting data from one or more data sources as claimed in claim 1, wherein the one or more data sources comprises at least one of text/html, text/plain, text/xml, excel, jpeg, zip, jar, cab, gzip and rar.

7. The system for automatically extracting data from one or more data sources as claimed in claim 1, wherein one or more target databases comprises at least one of SQL or NOSQL target databases.

8. A method of automatically extracting data from one or more data sources through one or more source channels and loading data contained therein to one or more target databases comprising:
loading one or more data sources from one or more source channels;
transforming data received from the one or more data sources by a data transformation module;
analyzing and organising the received data automatically for loading into the one or more target databases by a data processing module;
generating predefined data structures of the one or more target databases and loading therein through one or more connectors; and
storing metadata of the processed data for future usage by a metadata repository,
wherein the metadata regarding data structure of the one or more data sources is automatically extracted from the data sources and used to create predefined data structures of the one or more target databases.

9. The method of automatically extracting data from one or more data sources as claimed in claim 8, wherein analysing the structure of the received data automatically by the data processing module comprises at least one of machine learning, heuristics and statistical analysis.

10. The method of automatically extracting data from one or more data sources as claimed in claim 8, wherein analyzing and organising the received data automatically by the data processing module comprises at least one of:
identifying mime-type, extension and the metadata of the one or more data sources; and
identifying type and internal data structures (subtype) of the one or more data sources.

11. The method of automatically extracting data from one or more data sources as claimed in claim 8, comprising displaying the results of the analysis and the inferred data structures to a user on a user interface.

12. The method of automatically extracting data from one or more data sources as claimed in claim 11, comprising receiving user inputs for correcting information and entering additional file and data structures that override the automatically inferred data structures.

13. The method of automatically extracting data from one or more data sources as claimed in claim 12, comprising automatically re-creating the data structures of the one or more target databases and reprocessing the data based on the new data structures.

14. The method of automatically extracting data from one or more data sources as claimed in claim 8, comprising maintaining a history of the file types and subtypes and the metadata thereof.

15. The method of automatically extracting data from one or more data sources as claimed in claim 14, comprising combining the results of current file structure identification with a statistical analysis of the history of the previous file structures.

16. The method of automatically extracting data from one or more data sources as claimed in claim 15, further comprising improving the automatic identification of future data sources based on the previously processed file structures of the one or more data sources.

17. A computer program product, comprising a computer usable medium having a computer readable program code embodied therein, said computer readable program code adapted to be executed to implement a method of automatically extracting data from one or more data sources through one or more source channels and loading data contained therein to one or more target databases, said method comprising:
loading one or more data sources from one or more source channels;
transforming data received from the one or more data sources by a data transformation module;
analyzing and organising the received data automatically for loading into the one or more target databases by a data processing module;
generating predefined data structures of the one or more target databases and loading therein through one or more connectors; and
storing metadata of the processed data for future usage by a metadata repository,
wherein the metadata regarding data structure of the one or more data sources is automatically extracted from the data sources and used to create predefined data structures of the one or more target databases.
